(19) United States
(12) Patent Application Publication
(10) Pub. No.: US 2024/0122162 A1
(43) Pub. Date: Apr. 18, 2024

(54) Detachable Drinking Nipple for Poultry Waterer

(71) Applicant: The GSI Group (Shanghai) Co., Ltd, Shanghai (CN)

(72) Inventors: Yu Shao, Suzhou (CN); Guoqiang Yu, Shanghai (CN)

(21) Appl. No.: 18/296,432

(22) Filed: Apr. 6, 2023

(30) Foreign Application Priority Data
Apr. 29, 2022 (WO) PCT/CN2022/090424

(51) Int. Cl. A01K 39/02

(52) U.S. Cl. CPC A01K 39/0213

(57) ABSTRACT

A watering system for use in an animal house having at least one watering pipe and a plurality of nipple drinkers spaced along the watering pipe. The watering pipe has a pipe body that encloses a flow channel through which pressurized water is carried to each of the plurality of nipple drinkers. The pipe body has a flat nipple-facing surface. Each of the plurality of nipple drinkers has a nipple body having a pipe-facing surface that is brought adjacent the nipple-facing surface of the pipe body such that a nipple inlet extends into the flow channel, and wherein the nipple body has a fastener mechanism that detachably holds the nipple drinker against the nipple-facing surface such that each nipple drinker is detachably attached to the watering pipe 108 along the nipple-facing surface.

### CROSS-REFERENCE TO RELATED APPLICATIONS

This application is a continuation application of International Application No. PCT//CN2022/090424, filed Apr. 29, 2022, and entitled DETACHABLE DRINKING NIPPLE FOR POULTRY WATERER, the contents of which are hereby incorporated by reference in their entirety.

### BACKGROUND OF THE INVENTION

### Field of Invention

This disclosure relates to poultry watering systems, and more particularly to a detachable nipple connectable to a watering line of the watering system.

### Description of Related Art

Nipple drinker watering systems are commonly used to provide water to poultry and other small animals. These watering systems involve the use of several branching water supply lines extending the interior length of a house, such as a poultry house. Each water supply line has a series of spaced apart watering stations or nipple drinkers attached thereto so that the poultry may obtain water by pecking at a movable pin or lever in one of the nipples.

Periodically, it may be necessary to flush the watering lines and each of the nipple drinkers in order to clean out the watering system as material may build up over time due to, for instance, the introduction of sediment from the water source itself or from growers adding material to the water source, such as chlorine or medication. Such build-up of material in the watering system can interfere with proper water flow through the nipple drinkers and may eventually contribute to the malfunction of the nipple drinkers.

At present, most watering systems on the market have nipple drinkers that are substantially unremovable, which makes them difficult to clean and even directly replace. With the continuous improvement of technology and the diversification of product demand, a detachable drinking water nipple for poultry houses would be desirable.

### BRIEF SUMMARY

One aspect of the invention is directed to a watering system for use in an animal house having at least one watering pipe and a plurality of nipple drinkers spaced along the at least one watering pipe. The watering pipe includes a pipe body that encloses a flow channel through which pressurized water is carried to each of the plurality of nipple drinkers. The pipe body has a flat nipple-facing surface. Each of the plurality of nipple drinkers includes a sealing ball that is forced against a sealing bushing thereby forming a watertight seal to prevent leakage of water from the flow channel out through the nipple drinker, and a drinking water needle configured to displace the sealing ball from the sealing bushing to release drinking water through the nipple drinker. The nipple drinker further includes a nipple body having a pipe-facing surface that is brought adjacent the nipple-facing surface of the pipe body such that a nipple inlet extends into the flow channel. The nipple body includes a fastener mechanism that detachably holds the nipple drinker against the nipple-facing surface such that each nipple drinker is detachably attached to the watering pipe along the nipple-facing surface.

In one aspect, the fastener mechanism of the watering system includes a pair of ears, with each ear engaging a flange of the nipple-facing surface of the watering pipe. The fastener mechanism also includes a pair of tabs, where each one of the pair of tabs is operatively connected to one of the ears, the tabs and ears being made of a resilient material, such that in a first condition the tabs engage the flanges to securely hold the nipple body against the nipple-facing surface and in a second condition with the tabs depressed, the ears disengage from the flanges allowing the nipple drinker to be removed from the watering pipe.

Other technical features may be readily apparent to one skilled in the art from the following figures, descriptions, and claims. This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. The disclosed subject matter will be further explained with reference to the attached figures, wherein like structure or system elements are referred to by like reference numerals throughout the several views.

FIG. 1 is a schematic of a poultry watering system;

FIG. 2 illustrates an aspect of the subject matter in accordance with one embodiment.

FIG. 3 illustrates an aspect of the subject matter in accordance with one embodiment.

### DETAILED DESCRIPTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

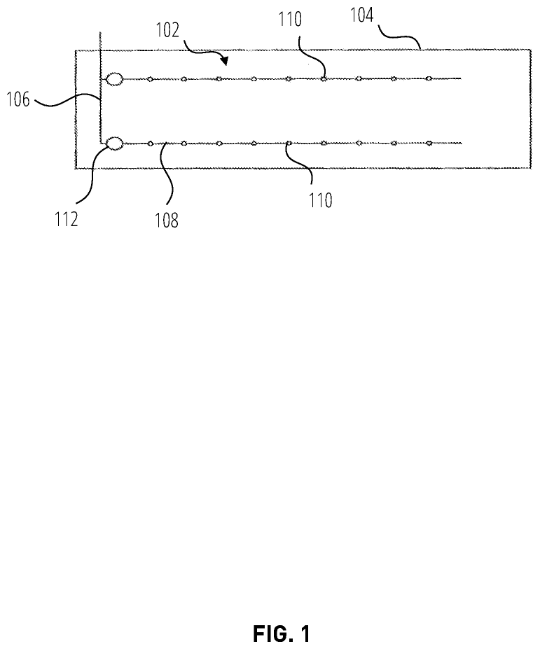

A watering system 102 for use in an animal house such as poultry house 104 is shown in FIG. 1. The watering system 102 includes a supply line 106 which is connected to at least one watering pipe 108, two of which are shown. A number of watering stations or nipple drinkers 110 are spaced along each watering pipe 108. As is known, nipple drinkers 110 for poultry houses 104 are activated by birds pecking against the nipple drinker 110 to release a supply of water. The pressure within the water watering pipes 108 is maintained at a suitable (e.g., about 6″-12″ of water) which is typically substantially less than the line pressure (e.g., 30-60 psi) in the supply line 106. Thus, water regulators 112 are positioned in the watering system 102 before the nipple drinkers 110. The regulators 112 are desirably placed at the beginning of the water watering pipes 108, as schematically shown in FIG. 1. As is known, the watering system 102 is typically suspended from the roof rafters of the poultry house 104 by a suspension system having a motorized winch and cable assembly (not shown) that is selectively operated to allow the watering system 102 to be raised and lowered so that the poultry house 104 may be cleaned and new bedding put down between poultry batches.

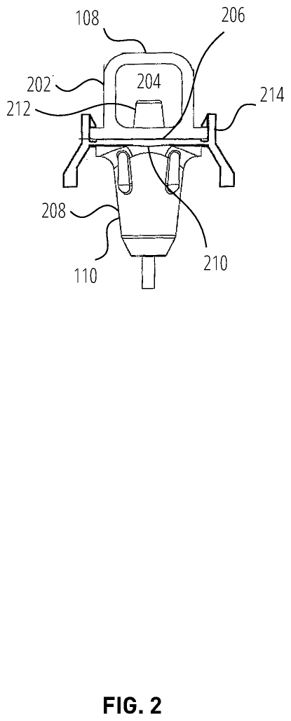

Turning now to FIG. 2, the watering pipe 108 on which the nipple drinkers 110 are mounted has a pipe body 202 that encloses a flow channel 204 through which water is carried to each nipple drinker 110. In the illustrated embodiment, the pipe body 202 has a generally rectangular cross-section such that the watering pipe 108 has a substantially flat nipple-facing surface 206. A nipple body 208 of each nipple drinker 110 has a pipe-facing surface 210 that is brought adjacent the nipple-facing surface 206 of the pipe body 202 such that a nipple inlet 212 extends into the flow channel 204. A fastener mechanism 214 holds the nipple drinker 110 securely, but detachably, against the nipple-facing surface 206 such that each nipple drinker 110 is detachably attached to the watering pipe 108 along the nipple-facing surface 206.

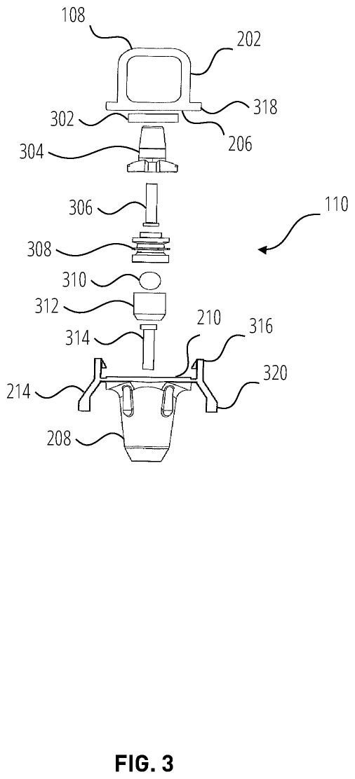

As best seen in FIG. 3, the nipple inlet 212 of each nipple drinker 110 mates with the pipe body 202 with a waterproof sealing ring 302 forced against the nipple-facing surface 206 by a sealing ring fastener 304. Extending through the sealing ring fastener 304 is a backflow needle 306 working in conjunction with a suitable limiting bushing 308 selected using sound engineering judgment. A sealing ball 310 is received adjacent a sealing bushing 312 that function to limit outward flow of water through the nipple drinker 110 except when activated by a chicken as will be explained below. The portion of the nipple drinker 110 exposed to the chicken includes a drinking water needle 314 and the nipple body 208. The nipple body 208 desirably surrounds and holds in place the other components of the nipple drinker 110.

When the flow channel 204 of the watering pipe 108 is pressurized, the sealing ball 310 is forced against the sealing bushing 312 thereby forming a watertight seal to prevent leakage of water from the flow channel out through the nipple drinker 110. When a chicken needs to drink water, the chicken pecks at the drinking water needle 314 causing the drinking water needle 314 to displace the sealing ball 310 from the sealing bushing 312. When the sealing ball 310 is temporarily separated from the sealing bushing 312, water flows along the drinking water needle 314 and out the nipple body 208 to provide drinking water to the chicken as would be understood by one skilled in the art.

According to the invention, an operator is able to disassemble the nipple drinker 110 from the watering pipe 108 by actuating the fastener mechanism 214. The fastener mechanism 214 includes a pair of ears 316, with each ear 316 engaging a flange 318 of the nipple-facing surface 206 of the watering pipe 108. In order to disassemble the nipple drinker 110, the operator presses on two tabs 320 positioned on the sides of the nipple body 208, each tab 320 is operatively connected to one of the ears 316. The tabs 320 and ears 316 are made of a resilient material such that in a first condition the tabs 320 engage the flanges 318 to securely hold the nipple body 208 against the nipple-facing surface 206. In a second condition with the tabs 320 depressed, the ears 316 disengage from the flanges 318. With the fastener mechanism 214 no longer holding the nipple drinker 110 against the nipple-facing surface 206 of the watering pipe 108, the nipple drinker 110 may be removed for cleaning or replacement as needed.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A watering system for use in an animal house having at least one watering pipe 108 and a plurality of nipple drinkers spaced along the at least one watering pipe, wherein the watering pipe comprises a pipe body that encloses a flow channel through which pressurized water is carried to each of the plurality of nipple drinkers, the pipe body having a nipple-facing surface, and wherein each of the plurality of nipple drinkers comprises a sealing ball that is forced against a sealing bushing thereby forming a watertight seal to prevent leakage of water from the flow channel out through the nipple drinker and a drinking water needle configured to displace the sealing ball from the sealing bushing to release drinking water through the nipple drinker, wherein the nipple drinker further comprises a nipple body having a pipe-facing surface that is brought adjacent the nipple-facing surface of the pipe body such that a nipple inlet extends into the flow channel, and wherein the nipple body comprises a fastener mechanism that detachably holds the nipple drinker against the nipple-facing surface such that each nipple drinker is detachably attached to the watering pipe along the nipple-facing surface.

2. The watering system of claim 1 wherein the fastener mechanism includes a pair of ears 316, with each ear engaging a flange of the nipple-facing surface of the watering pipe.

3. The watering system of claim 2 wherein the fastener mechanism comprises a pair of tabs, wherein each one of the pair of tabs is operatively connected to one of the ears, the tabs and ears being made of a resilient material such that in a first condition the tabs engage the flanges to securely hold the nipple body against the nipple-facing surface and in a second condition with the tabs depressed, the ears disengage from the flanges allowing the nipple drinker to be removed from the watering pipe.
